(19) United States
(12) Patent Application Publication
(10) Pub. No.: US 2013/0124611 A1
(43) Pub. Date: May 16, 2013

(54) UNIFIED REPOSITORY & TOOL INFRASTRUCTURE

(71) Applicants: Frederik THORMAEHLEN, Mannheim (DE); Ulf FILDEBRANDT, Oftersheim (DE); Peter CHRISTIANSEN, Wiesloch (DE); Sebastian KOERNER, Heidelberg (DE)

(72) Inventors: Frederik THORMAEHLEN, Mannheim (DE); Ulf FILDEBRANDT, Oftersheim (DE); Peter CHRISTIANSEN, Wiesloch (DE); Sebastian KOERNER, Heidelberg (DE)

(73) Assignee: SAP AG, Walldorf (DE)

(21) Appl. No.: 13/297,661

(22) Filed: Nov. 16, 2011

(51) Int. Cl. G06F 15/16

(52) U.S. Cl. 709/203

(57) ABSTRACT

A system and method are described herein that provide a repository and tool infrastructure (“RTI”) that provides common capabilities on both a client and server end based on standardized communication patterns and a unifying protocol that decouples existing repositories from multiple tools. The repository and tool infrastructure interface interacts with a single development editing tool and any repository housed on a server end and is implemented to each server or client technology if the common capabilities and communication patterns are fulfilled.

### FIELD OF THE INVENTION

The present invention relates to a process for managing multiple digital entities across multiple repositories. The present invention further relates to using a repository and tool infrastructure to create and modify digital entities across multiple repositories. The present invention further relates to a process for providing common capabilities on a client and server side based on standardized communication patterns and a unifying protocol to manage the entities in connected repositories.

### BACKGROUND INFORMATION

Digital repositories are managed directories in which digital entities are stored and described in digital formats accessed by a network of computers. These digital entities can be in a wide variety of formats, including as software (such as Perforce™, ClearCase™, Git™, or ABAP™ program repositories), documents, metadata, tasks (such as JIRA™), or processes. These repositories allow for fast and efficient information retrieval of the stored and catalogued digital entities.

Repositories can be implemented through a wide variety of manners. One of these manners is through early integration using only a single centrally located repository. In such an implementation, which may be used for example with ABAP™ program files, stored digital entities exist only transiently in a main memory or cache on a local repository system. In this implementation, the local system is frequently persisted by a connected central repository.

Another implementation in which a repository can be set up is through late integration with a single centrally located repository. In this implementation, which may be used for example with Perforce™ program files, stored digital entities are persisted on a local repository system and checked into a connected central repository. The central repository is not always connected to the local system as it is the case with the early integration system; the central repository is only sometimes connected.

Repositories can also be implemented in multi-repository systems. In such systems, multiple repositories are implemented through late integration, with each of the repositories having merge capabilities. In this implementation, a local repository system persists the stored digital entities, and these digital entities are merged with other entities having the same version or identification number. Any modifying of these entities occurs on other local repository systems.

A problem with the current implementation of repositories is that a repository itself only includes the functionality for the version management of its stored digital entities. This inevitably means that many steps in the creation or modification of the digital entities has to be done manually by a user. A user must identify the correct repository and then find and connect to the identified individual repository. Subsequently, the user has to choose an appropriate tool for modifying that pertains to modifying a particular entity. Moreover, the user also needs to identify and locate the version of the digital entity that is to be modified and identify a location for creating a new digital entity. Additionally, the user must identify the location and version number of any previous versions, if they exist, of the digital entity.

Any version management of an individual repository can only manage the versions of the digital entities stored in that individual repository, and cannot manage the versions of digital entities stored in other repositories. Existing tools used to create or modify digital entities are implemented on a 1:1 basis between the tool and the repository, where for each separate repository, a separate tool is used to create or modify the entities in that repository.

FIG. 1 illustrates an existing system with multiple tools and multiple repositories. The system includes a plurality of development servers 20.1-20.n. For example, as illustrated in FIG. 1, servers 20.1, 20.2, and 20.n may correspond to ABAP servers, servers 20.3 and 20.4 may correspond to Java servers, and server 20.5 may correspond to any server type. Each server may include a repository 10.1-10.n and an external storage element. The system may also include individual domain specific development editing tools 30.1-30.n. on a development client side. Each of the individual tools 30.1-30.n may be mapped to a specific corresponding repository and server. For example, in the system in FIG. 1, tool 30.1 may work in conjunction with repository 10.1 on server 20.1. Tool 30.1 may not, for example, access repository 10.2 on server 20.2. Conversely, repository 10.1 may only be accessed by tool 30.1 and may not be accessed by any of the other tools 30.2-30.n. The tools and repositories in this given structure therefore look like a stack. This has the negative effect of creating a 1:1 relationship between the domain specific development editing tool on the development client and the repository on the development server, requiring a domain specific development editing tool for each of the repositories. This results in an overly large and inefficient system.

Furthermore, since each domain specific development editing tool in the system in FIG. 1 has its own domain specific consumer component on the client side and a domain specific resource provider on the server side, the client and the server have to be connected by a user, and the domain specific resource provider component on the serer side can only be used for the specific domain development editing tool. The domain specific resource provider cannot be used for other existing domain specific development editing tools.

Thus there remains a need in the art, for a system and method having a universal development editing tool that can create and modify digital entities in multiple repositories. There also remains a need in the art, for a system and method which allows for the version management of the digital entities in a repository without using multiple development editing tools. There also remains a need in the art for a cross access system which allows a development editing tool access to multiple repositories regardless of content.

### SUMMARY OF THE INVENTION

A system and method are described herein that allow for the creation and modification of digital entities stored across multiple repositories, regardless of the repository or hosting server. A repository and tool infrastructure (“RTI”) provides common capabilities on both a client and server end based on standardized communication patterns and a unifying protocol that decouples existing repositories from multiple tools. The repository and tool infrastructure interface interacts with a single development editing tool and any repository housed on a server end and may be implemented to each server or client technology if the common capabilities and communication patterns are fulfilled.

In particular, the exemplary embodiments and/or exemplary methods of the present invention are directed to a method for a system having a unified repository and tool infrastructure (“RTI”) to manage digital entities across repositories, the system comprising: a user terminal, wherein a tool infrastructure component of the RTI is situated on the user terminal; a development tool situated on the user terminal; a local server, wherein a repository infrastructure component of the RTI is situated on the local server, the repository infrastructure component communicating to the tool infrastructure component through a representational state transfer (“REST”) interface; and at least one repository located on the local server.

The exemplary embodiments and/or exemplary methods of the present invention further provide for the foregoing system in which the repository infrastructure component communicates to the at least one repository through another REST interface.

The exemplary embodiments and/or exemplary methods of the present invention further provide for the foregoing system in which the development tool is an open-source tool.

The exemplary embodiments and/or exemplary methods of the present invention further provide for the foregoing system further including a central server.

The exemplary embodiments and/or exemplary methods of the present invention further provide for the foregoing system in which a federation infrastructure component of the RTI is situated on the central server, the federation infrastructure component communicating to the tool infrastructure component and the repository infrastructure component through REST interfaces.

The exemplary embodiments and/or exemplary methods of the present invention further provide for the foregoing system in which a transformation infrastructure component of the RTI is situated on the central server, the transformation infrastructure component communicating to the tool infrastructure component and the repository infrastructure component through REST interfaces.

The exemplary embodiments and/or exemplary methods of the present invention further provide for the foregoing system in which a transformation infrastructure component of the RTI is situated on the central server, the transformation infrastructure component communicating to the tool infrastructure component, the repository infrastructure component, and the federation infrastructure component through additional REST interfaces.

The exemplary embodiments and/or exemplary methods of the present invention further provide for the foregoing system in which additional repositories are connected to the transformation infrastructure component.

The exemplary embodiments and/or exemplary methods of the present invention further provide for the foregoing system in which the additional repositories are located on additional servers.

The exemplary embodiments and/or exemplary methods of the present invention further provide for a method for managing digital entities across repositories, the method comprising: identifying a developmental tool situated on a user terminal; communicating from the development tool to a local server via a tool infrastructure component of a unified repository and tool infrastructure (“RTI”); receiving the communication from the tool infrastructure component on the local server via a repository infrastructure component of the RTI, the communication occurring through a representational state transfer (“REST”) message; and accessing the data entities on at least one repository located on the local server.

The exemplary embodiments and/or exemplary methods of the present invention further provide for the foregoing method further comprising the transmitting of an additional REST message to communicate between the repository infrastructure component and the at least one repository.

The exemplary embodiments and/or exemplary methods of the present invention further provide for the foregoing method in which the development tool is an open-source tool.

The exemplary embodiments and/or exemplary methods of the present invention further provide for the foregoing method further comprising the retrieving of content about requested resources from a federation infrastructure component located on a central server via an additional REST message.

The exemplary embodiments and/or exemplary methods of the present invention further provide for the foregoing method further comprising the providing of access to additional repositories through a transformation infrastructure component located on a central server via an additional REST message.

The exemplary embodiments and/or exemplary methods of the present invention further provide for the foregoing method in which additional repositories are located on additional servers.

The exemplary embodiments and/or exemplary methods of the present invention further provide for a method for combining subprocesses stored across multiple repositories, the method comprising: identifying, with a unified repository and tool infrastructure (“RTI”), locations of the subprocesses in at least one repository; determining, with the RTI, a location for storage for a combined process; retrieving the subprocesses from the at least one repository; combining the retrieved subprocesses into the combined process; and storing the combined process on a central server.

The exemplary embodiments and/or exemplary methods of the present invention further provide for a method for developing source code from previous releases of the source code, the method comprising: identifying, with a unified repository and tool infrastructure (“RTI”), locations of systems or service containing the previous releases of the source code; comparing, with the RTI, the source code with each of the previous releases of the source code to determine changes made in each release; and generating specific differences between the source code and the previous releases of the source code.

The exemplary embodiments and/or exemplary methods of the present invention further provide for a method for developing a mobile application integrating objects between distinct platforms, the method comprising: identifying, with a unified repository and tool infrastructure (“RTI”), a location of middleware on different platforms to be integrated with a client platform; accessing, with the RTI, resources on the distinct platforms; and federating the resources on the different platforms with the client platform to integrate with the client platform.

### BRIEF DESCRIPTION OF THE DRAWINGS

FIG. 1 is a diagram of a system having individual development editing tools for each repository.

FIG. 2 is a diagram of a user terminal displaying the unified repository and tool infrastructure according to the current invention.

FIG. 3 is a diagram of a system with a unified repository and tool infrastructure according to the current invention.

FIG. 4 is a diagram of the unified repository and tool infrastructure interfacing directly with a local development server in an example landscape according to the current invention.

FIG. 5 is a diagram of the unified repository and tool infrastructure interfacing directly with a local development server with an added federation infrastructure in an example embodiment according to the current invention.

FIG. 6 is a diagram of the unified repository and tool infrastructure interfacing directly with a local development server with an added transformation infrastructure in an example embodiment according to the current invention.

FIG. 7 is a diagram of the unified repository and tool infrastructure interfacing directly with a local development server with added federation and transformation infrastructures in an example embodiment according to the current invention.

### DETAILED DESCRIPTION

The subject invention will now be described in detail for specific preferred embodiments of the invention, it being understood that these embodiments are intended only as illustrative examples and the invention is not to be limited thereto.

Using domain specific development tools to modify and create digital entities in multiple repositories creates an overabundant and inefficient system. Exemplary embodiments of the present invention provide a system and method that allow for the creation and modification of digital entities stored across multiple repositories, regardless of the repository or hosting server. A repository and tool infrastructure (“RTI”) provides common capabilities on both a client and server end based on standardized communication patterns and a unifying protocol that decouples existing repositories from multiple tools. The repository and tool infrastructure interface interacts with a single development editing tool and any repository housed on a server end and may be implemented to each server or client technology if the common capabilities and communication patterns are fulfilled. The system and method may provide an infrastructure that allows for an open-source development tool to interact with a plurality of repositories.

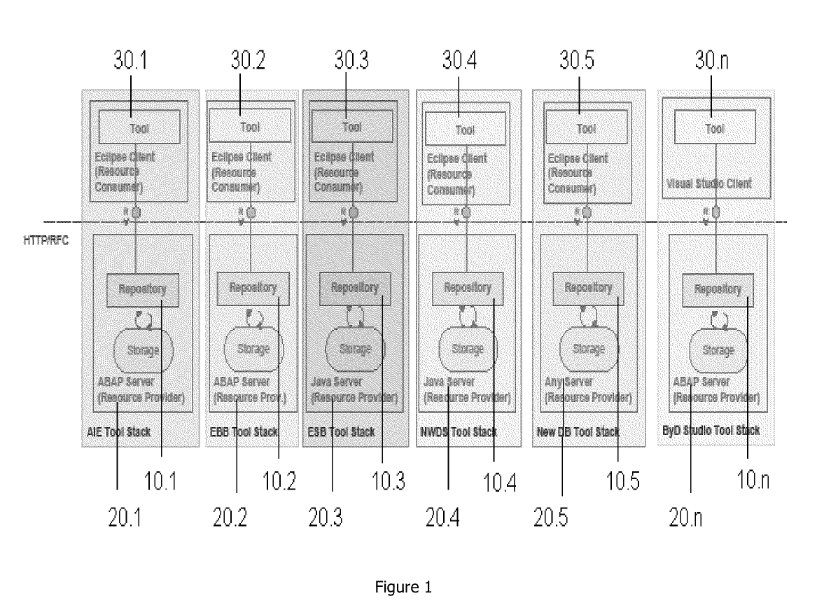

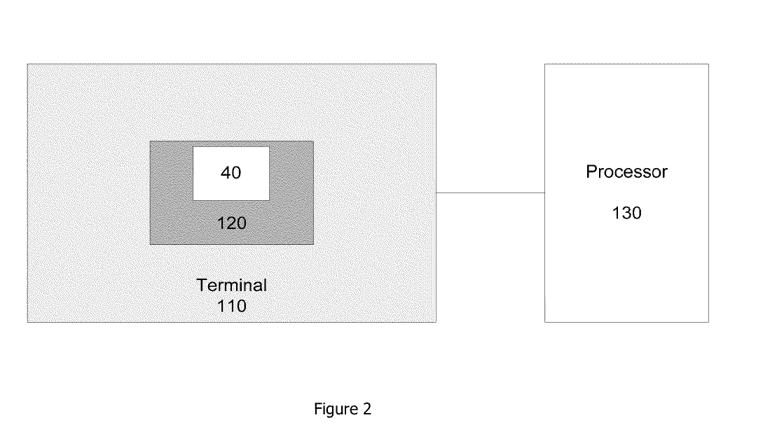

FIG. 2 illustrates a diagram of a user terminal 110 displaying a client application 120 integrating repository and tool infrastructure 40 on the terminal. Application 120 may be executed, for example, by processor 130 and may be displayed on user terminal 110 to a user. Each user terminal may contain a display or monitor that displays the client application. The client application 120 displayed on the user terminal 110 may connect to servers 20.1-20.n illustrated in FIG. 1. User terminal 110, may be embodied, for example, as a desktop, laptop, hand-held device, personal digital assistant (PDA), television set-top Internet appliance, mobile telephone, smart phone, iPod™, iPhone™, iPad™, etc., or as a combination of one or more thereof, or other comparable device.

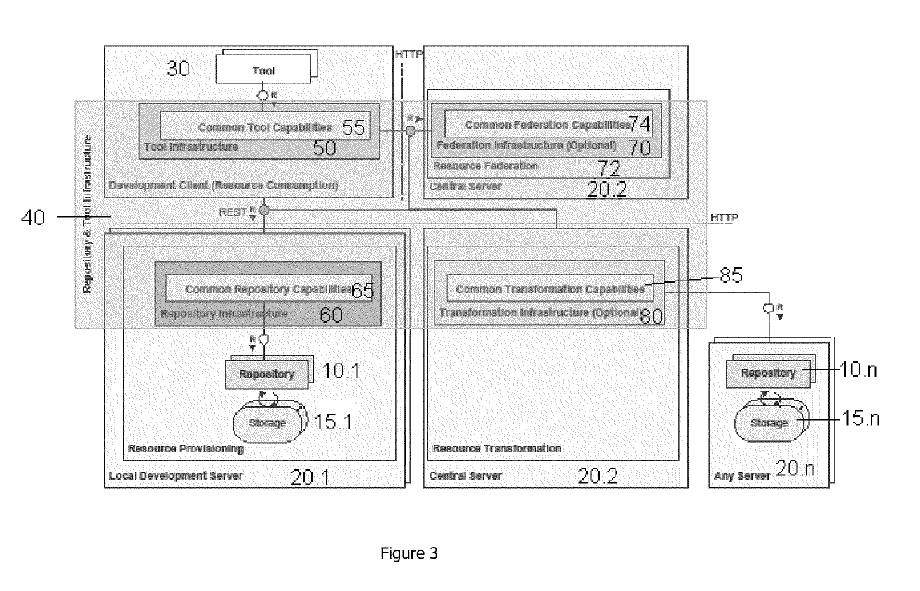

FIG. 3 illustrates a system diagram of a repository and tool infrastructure 40 interfaced between a development editing tool 30 and repositories 10.1 and 10.n. Tool 30 may be a generic development editing tool, and in an embodiment, may an open-source editing tool. Tool 30 may be situated on a development client, as depicted in FIG. 3.

The system includes a local development server 20.1 and central server 20.2, as illustrated in FIG. 3, or any additional type of server 20.n. Local development server 20.1, central server 20.2, and server 20.n, may be implemented locally or remotely using processing circuits or devices or combinations thereof, such as, for example, a central processing unit (CPU) of a personal computer (PC) or other workstation processor, such as processor 130.

In the example embodiment of FIG. 3, local development server 20.1 may include a repository 10.1 and a storage database 15.1. Repository 10.1 may contain a plurality of digital entities in accordance with the local development server 20.1. These digital entities may include development artifacts. For example, in an embodiment where local development server 20.1 is an ABAP server, digital entities in repository 10.1 may correspond to ABAP better process models. In an embodiment where local development server 20.1 is a Java server, digital entities in repository 10.1 may correspond to Java better process models.

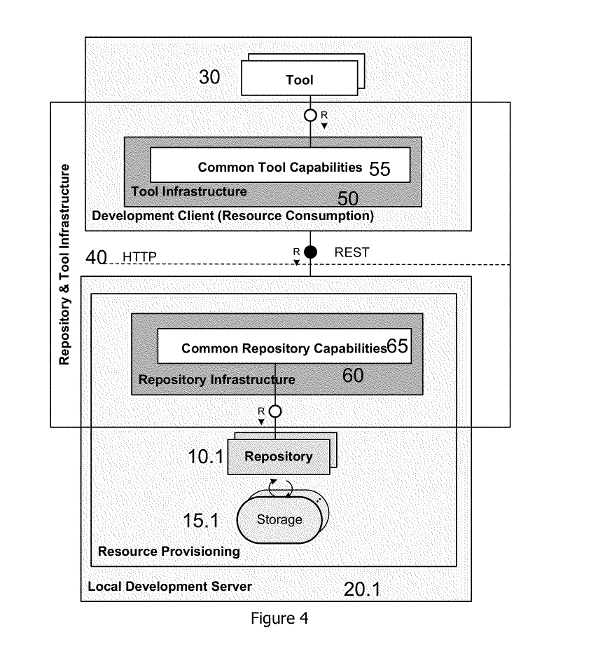

The repository and infrastructure (“RTI”) 40 may contain multiple infrastructure components, including a tool infrastructure 50, a repository infrastructure 60, a federation infrastructure 70, and a transformation infrastructure 80. Embodiments of the invention may include one or more combinations of infrastructures 50-80 as illustrated further in FIGS. 4-7. FIGS. 4-7 further illustrate the scalability of the RTI. Infrastructure components and repositories may be added or removed to interact with a desired development landscape, as illustrated in FIGS. 4-7. The RTI may provide extensibility of a development landscape.

Tool infrastructure 50 may be situated on a development client side as illustrated in FIG. 3. Tool infrastructure 50 may include common tool capabilities 55 for development. The tool capabilities 55 may be standardized tool capabilities that may be used by a variety of different tools. These tool capabilities 55 may be displayed on client application 120. Such common tool capabilities that may be displayed on the interface include, but are not restricted to: Browser Integration, EMF Graphity, Search, Where Used, Governance, Type Modeling, XText, Tasks, Semantic File System, Service/Resource Framework, Browser Framework, Java GUI Integration, Navigation, and Compatibility. The presence of the common tool capabilities may assist a client developer in migrating the developer's own implementation into a common one. Tool capabilities 55 may be mapped to existing projects on client application 120. In an embodiment, each capability may be addressed by one or more projects. In another embodiment, each project may address one or more projects.

Tool infrastructure 50 may communicate with repository infrastructure 60 which may be situated on a local development server 20.1. Local development server 20.1 may be a server that is implemented locally. Local development server 20.1 may also include a repository 10.1 and an external storage database 15.1. Repository 10.1 may be any type of repository storing a certain type of digital format. Repository 10.1 may communicate with repository infrastructure 60. Tool infrastructure 50 may communicate with repository infrastructure 60 through a representational state transfer (“REST”) interface. A REST interface may allow for a suitable interface between a client and a server, and REST http message based communication may allow for a suitable exchange of information between the tools and the repositories, and among the repositories themselves. Tool 30 and tool infrastructure 50 may follow the release cycle of repository 10.1.

Repository infrastructure 60 of the RTI 40 may also interact directly with repository 10.1 through REST http message based communication. Repository infrastructure 60 may include common repository capabilities 65. The repository capabilities 65 may be standardized repository capabilities that may be used by a variety of servers and repositories. These capabilities 65 may work in conjunction with the common tool capabilities 55. Newly created data content may be put into repository 10.1, and tool infrastructure 50 may subscribe to the repository. Additionally, any modifications or deletions of the data entities in repository 10.1 may be done and stored in repository 10.1.

The RTI 40 may also contain an optional federation infrastructure component 70 in resource federation 72 that is situated on central server 20.2. The federation infrastructure 70 may connect to the other infrastructure components, tool infrastructure 50 and repository infrastructure 60 through REST http message based communication. Like repository infrastructure 60, federation infrastructure 70 may be situated on the server end, but unlike repository infrastructure 60 which may situated on a local server, federation infrastructure 70 may be situated on a remote central server. Federation infrastructure 70 may assist to retrieve additional content for a requested development artifact. This may also be accomplished using the various REST interfaces, which may allow for an exchange of various digital formats across the repositories and the federation infrastructure 70. Federation infrastructure 70 may include common federation capabilities 74. In instances in which development is only done on a local server, such as FIG. 4, there may be no federation infrastructure 70.

Tool 30 may request development artifacts (resources) through REST http message based communication from federation infrastructure 70. The resource may be identified by the federation infrastructure and may be delegated to a resource provider. Federation infrastructure 70 may identify information sent in conjunction with the REST message resource request and may identify and supply the requested resource to tool 30.

The RTI 40 may also include a transformation infrastructure 80 that is situated on central server 20.2. In an example embodiment, transformation infrastructure component 80 may be situated on the same server as the federation infrastructure component. Transformation infrastructure 80 may connect to the other infrastructure components 50, 60, and 70, through REST interfaces. Transformation infrastructure 80 may contain common transformation capabilities 85. These capabilities may be standardized transformation capabilities that may be used in general for transformation on a server side. Transformation infrastructure 80 may connect the individual repositories to each other, and may provide access across multiple repositories. In FIG. 3, transformation infrastructure 80 may be connected to repository 10.1 on local development server 20.1 and any other connected repositories, such as repository 10.n, connected to storage database 15.n, on any type of server 20.n.

The infrastructure components 50, 60, 70, and 80 may allow for the combining of different entities of a different type. For example, a developer may have a business model for which they wish to integrate with source code. The source code may be defined in a single repository or may be split in multiple repositories. The infrastructure components may allow for the integration of the source code to business objects and event descriptions. The RTI 40 may read the content out of the source code and link via the federation infrastructure 70 and tool 30.

FIG. 4 illustrates a diagram of an example embodiment of a landscape where the unified repository and tool infrastructure is only connected to a local development server. In this example embodiment, a central server may not exist, and the development client may be only connected to local development server 20.1. This may correspond to a simple landscape in which there is a 1:1 relationship between tool 30 and the repositories (there being only one). In this example embodiment, the RTI 40 may only include the tool infrastructure component 50 and the repository infrastructure component 60. The RTI 40 may not include federation infrastructure 70 and transformation infrastructure 80 because no federation or transformation is necessary. Because only one repository 10.1 is present in the landscape in FIG. 4, the transformation infrastructure 80 is not needed to connect to additional repositories. Additionally, since no central server is present, the federation infrastructure 70 is not needed to retrieve content for requested development artifacts/resources.

The tool infrastructure component 50 on the development client may connect to the repository infrastructure component 60 through a REST interface using REST http message based communication. The repository infrastructure component 60 may also communicate to repository 10.1 through REST http message based communication.

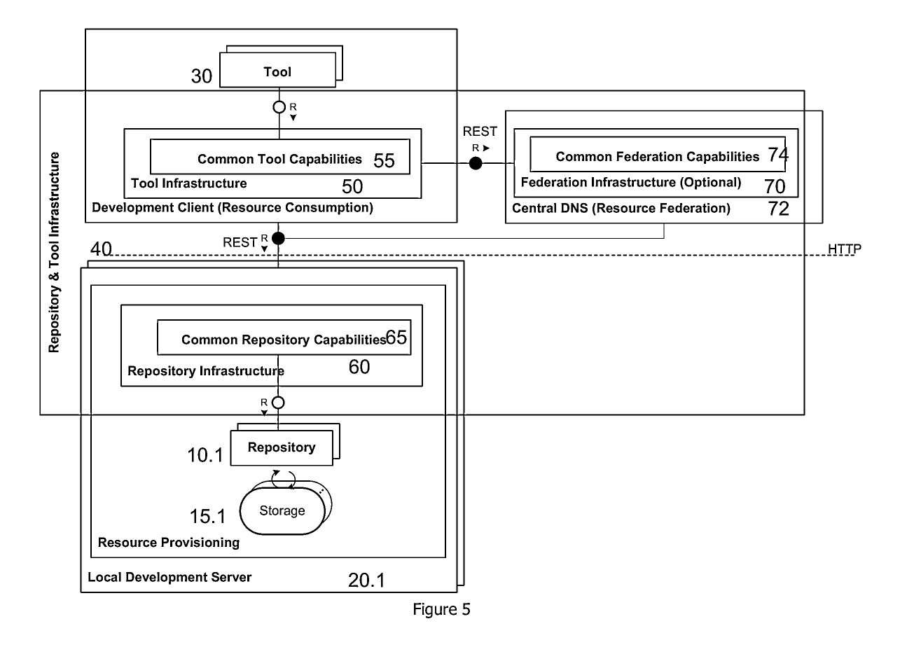

FIG. 5 illustrates a diagram of an example embodiment of a landscape where the unified repository and tool infrastructure is connected to many development servers and to a central server through a federation infrastructure component. In this example embodiment, the development client may be connected to development servers 20.1 and to central server 20.2.

In this example embodiment, the RTI 40 may include the tool infrastructure component 50, the repository infrastructure component 60, and the federation infrastructure component 70. In contrast to the example embodiment in FIG. 4, in the example embodiment in FIG. 5, the federation infrastructure 70 may be needed to retrieve content for requested development artifacts/resources from a central server 20.2, which is present to link to resources in development servers 20.1. The RTI 40 may not include transformation infrastructure 80 because no resource transformation is necessary.

The tool infrastructure component 50 on the development client may connect to the repository infrastructure component 60 and the federation infrastructure component 70 through REST interfaces using REST http message based communication. The repository infrastructure component 60 may also communicate to repository 10.1 through REST http message based communication.

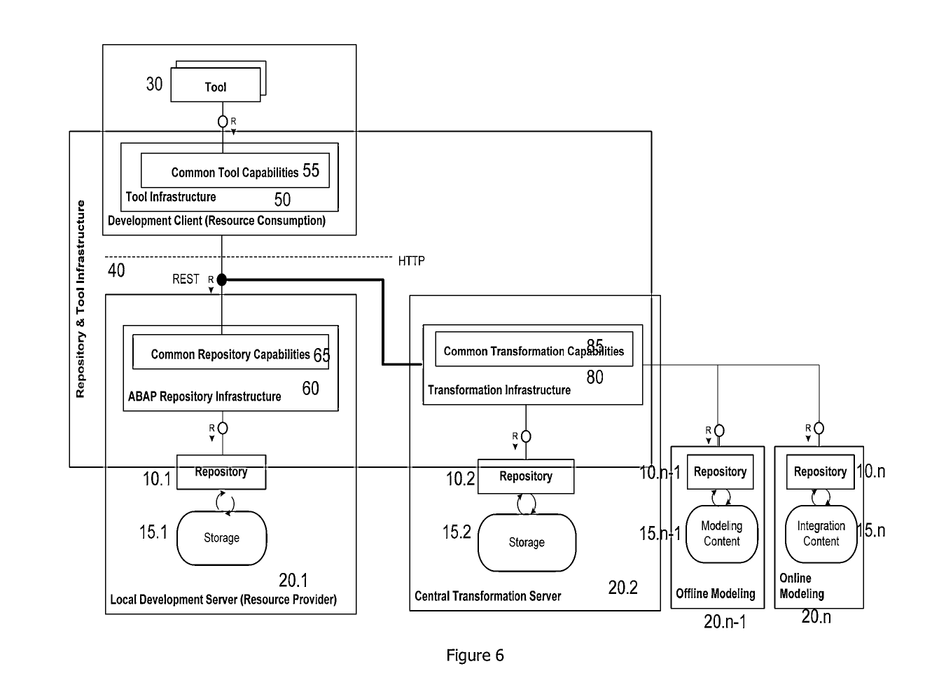

FIG. 6 illustrates a diagram of an example embodiment of a landscape where the unified repository and tool infrastructure is connected to a local development server and to a central server through a transformation infrastructure component. In this example embodiment, the development client may be connected to development servers 20.1 and to central server 20.2.

In this example embodiment, the RTI 40 may include the tool infrastructure component 50, the repository infrastructure component 60, and the transformation infrastructure component 80. In contrast to the example embodiments in FIGS. 4 and 5, in the example embodiment in FIG. 6, the transformation infrastructure 80 may be needed to transform resources from the repositories 20.n-1 and 20.n in a way that they can be consumed by the tools 30. In this example embodiment, as illustrated in FIG. 6, an additionally repository may be situated on central server 20.2. A storage database may also be connected to repository 10.2 and situated on central server 20.2, which may be needed for the resource transformation rules, such as XSLT.

A plurality of additional repositories on other servers may be connected to transformation infrastructure component 80 which may acquire access across each of the servers. In the example landscape, as illustrated in FIG. 6, an additional offline server 20.n-1 may be connected to transformation infrastructure component 80. Server 20.n-1 may include repository 10.n-1 and a storage database 15.n-1 storing modeling content. Transformation infrastructure component 80 may also be connected to server 20.n. Server 20.n may include repository 10.n and database 15.n storing integration content.

In this example embodiment, the RTI 40 may not include federation infrastructure 70 because no federation is necessary. In this embodiment, federation infrastructure 70 is not needed to retrieve content for requested development artifacts/resources.

The tool infrastructure component 50 on the development client may connect to the repository infrastructure component 60 and the transformation infrastructure component 80 through REST interfaces using REST http message based communication. The repository infrastructure component 60 may also communicate to repository 10.1 through REST http message based communication. The transformation infrastructure component 80 may also communicate to repositories 10.2, 10.n-1, and 10.n, through REST http message based communication.

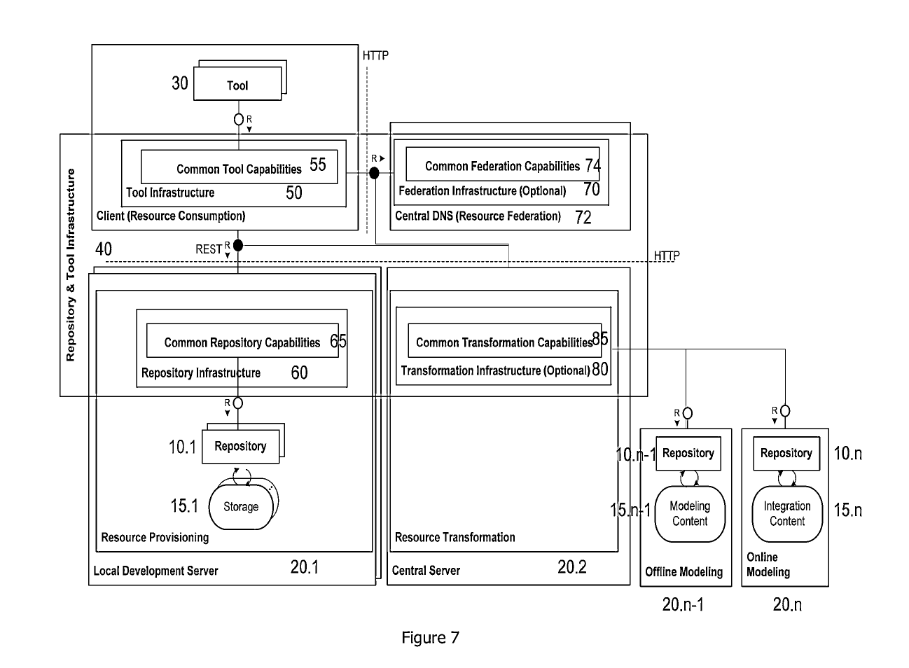

FIG. 7 illustrates a diagram of an example embodiment of a landscape where the unified repository and tool infrastructure is connected to a local development server and to a central server through a transformation infrastructure component and a federation infrastructure component. In this example embodiment, the development client may be connected to development servers 20.1 and to central server 20.2. The embodiment depicted in FIG. 7 may be identical or similar to the system design of the RTI 40 in FIG. 3.

In this example embodiment, the RTI 40 may include the tool infrastructure component 50, the repository infrastructure component 60, the federation infrastructure component 70, and the transformation infrastructure component 80. In contrast to the example embodiments in FIGS. 4 and 5, in the example embodiment in FIG. 7, the transformation infrastructure 80 may be needed in this embodiment to transform resources from the repositories 20.n-1 and 20.n in a way that they can be consumed by the tools 30. In contrast to the example embodiment in FIG. 6, in the example embodiment in FIG. 7, the federation infrastructure 70 may be needed to retrieve content for requested development artifacts/resources from the central server 20.2. In this example embodiment, as illustrated in FIG. 7, an additionally repository may be situated on central server 20.2. A storage database may also be connected to repository 10.2 and situated on central server 20.2.

A plurality of additional repositories on other servers may be connected to transformation infrastructure component 80 which may acquire access across each of the servers. In the example landscape, as illustrated in FIG. 7, an additional offline server 20.n-1 may be connected to transformation infrastructure component 80. Server 20.n-1 may include repository 10.n-1 and a database 15.n-1 storing modeling content. Transformation infrastructure component 80 may also be connected to server 20.n. Server 20.n may include repository 10.n and database 15.n storing transformation content.

The tool infrastructure component 50 on the development client may connect to the repository infrastructure component 60, the federation infrastructure component 70, and the transformation infrastructure component 80 through REST interfaces using REST http message based communication. The repository infrastructure component 60 may also communicate to repository 10.1 through REST http message based communication. The transformation infrastructure component 80 may also communicate to repositories 10.2, 10.n-1, and 10.n, through REST http message based communication.

The RTI 40 may be implemented in a variety of use cases. In an example embodiment, the RTI 40 may be used to combine processes. For example, a developer may wish to combine multiple subprocesses that are located in separate repositories and are of different resource formats. The RTI may identify the location of the subprocesses and then identify a location for a combined process to be stored. If, for example, two subprocesses are stored in two separate repositories on local servers, the RTI may identify the location of the subprocesses, retrieve the subprocesses, and then store a combined process on a central server. In an embodiment, one subprocess may be transformed in advance before retrieval. In an alternate embodiment, the combined process may store only a minimal set of necessary additional information which may not be stored in the local subprocesses already. This may enable the developer to combine processes without having to know and specify the location of the actual subprocesses. In previous systems, a change in the development landscape may require the federation configuration to be changed centrally. A developer using this previous system would need to know the name of any new repository system.

In an example embodiment, the RTI 40 may be used during source code development.

For example, there may have been three previous releases of a source code, with each release stored in a separate repository. If a developer wishes to make changes for a fourth release, the RTI 40 may assist in this manner by making a code comparison between the different releases of the source code. The RTI 40 may identify the system and the service packs in which previous source codes were located. The RTI 40 may assist in comparing the source code in each release with each other to determine the changes made in each release. This may enable specific comparisons between different releases of the source code.

In another example embodiment, the RTI 40 may be used with tool development. A new tool 30 may be developed to be used in conjunction with the RTI 40. The common tool capabilities of the RTI 40 may be changed by a developer so that the RTI 40 can be integrated with any future developed tools.

In an example embodiment, the RTI 40 may be used in conjunction with a development project for a mobile application. In an example embodiment, the mobile application may on the android platform. A developer may need some specific middleware for the development of the android client. If the middleware is a part of another development or platform, the android client or the middleware may not be able to be combined, as an explicit connection by the developer between the client platform to the repository may be necessary. If there are multiple platforms, the RTI 40 may gain resource based access to each of the platforms. The RTI may integrate the android client with the middleware using the federation infrastructure component 70, providing a simplified and end-to-end development process.

In an example embodiment, the RTI 40 may be used to assist in the development process even if a landscape has changed. In previous implementations, a landscape may have been designed for a specific development. Each repository and tool would have to be changed based on any changes made to the development landscape. The RTI 40 may allow for the retention of each of the repositories and may require no modification of the repositories. This may lead to an enhanced ability to introduce changes to a development process faster and more efficiently.

Several embodiments of the invention are specifically illustrated and/or described herein.

However, it will be appreciated that modifications and variations of the invention are covered by the above teachings and within the purview of the appended claims without departing from the spirit and intended scope of the invention.

What is claimed is:

1. A system having a unified repository and tool infrastructure to manage digital entities across repositories, the system comprising:
a user terminal, wherein a tool infrastructure component of the unified repository and tool infrastructure is situated on the user terminal;
a development tool situated on the user terminal;
a local server, wherein a repository infrastructure component of the unified repository and tool infrastructure is situated on the local server, the repository infrastructure component communicating to the tool infrastructure component through a representational state transfer interface; and
at least one repository located on the local server.

2. The system according to claim 1, wherein the repository infrastructure component communicates to the at least one repository through another representational state transfer interface.

3. The system according to claim 1, wherein the development tool is an open-source tool.

4. The system according to claim 1, further comprising:
a central server.

5. The system according to claim 4, wherein a federation infrastructure component of the unified repository and tool infrastructure is situated on the central server, the federation infrastructure component communicating to the tool infrastructure component and the repository infrastructure component through representational state transfer interfaces.

6. The system according to claim 4, wherein a transformation infrastructure component of the unified repository and tool infrastructure is situated on the central server, the transformation infrastructure component communicating to the tool infrastructure component and the repository infrastructure component through representational state transfer interfaces.

7. The system according to claim 5, wherein a transformation infrastructure component of the unified repository and tool infrastructure is situated on the central server, the transformation infrastructure component communicating to the tool infrastructure component, the repository infrastructure component, and the federation infrastructure component through additional representational state transfer interfaces.

8. The system according to claim 6, wherein additional repositories are connected to the transformation infrastructure component.

9. The system according to claim 7, wherein additional repositories are connected to the transformation infrastructure component.

10. The system according to claim 8, wherein the additional repositories are located on additional servers.

11. The system according to claim 9, wherein the additional repositories are located on additional servers.

12. A method for managing digital entities across repositories, the method comprising:
identifying a developmental tool situated on a user terminal;
communicating from the development tool to a local server via a tool infrastructure component of a unified repository and tool infrastructure;
receiving the communication from the tool infrastructure component on the local server via a repository infrastructure component of the unified repository and tool infrastructure, the communication occurring through a representational state transfer message; and
accessing the data entities on at least one repository located on the local server.

13. The method according to claim 12, further comprising:
transmitting an additional representational state transfer message to communicate between the repository infrastructure component and the at least one repository.

14. The method according to claim 12, wherein the development tool is an open-source tool.

15. The method according to claim 12, further comprising:
retrieving content about requested resources from a federation infrastructure component located on a central server via an additional representational state transfer message.

16. The method according to claim 12, further comprising:
providing access to additional repositories through a transformation infrastructure component located on a central server via an additional representational state transfer message.

17. The method according to claim 16, wherein the additional repositories are located on additional servers.

18. A method for combining subprocesses stored across multiple repositories, the method comprising:
identifying, with a unified repository and tool infrastructure, locations of the subprocesses in at least one repository;
determining, with the unified repository and tool infrastructure, a location for storage for a combined process;
retrieving the subprocesses from the at least one repository;
combining the retrieved subprocesses into the combined process; and
storing the combined process on a central server.

19. A method for developing source code from previous releases of the source code, the method comprising:
identifying, with a unified repository and tool infrastructure, locations of systems or service containing the previous releases of the source code;
comparing, with the unified repository and tool infrastructure, the source code with each of the previous releases of the source code to determine changes made in each release; and
generating specific differences between the source code and the previous releases of the source code.

20. A method for developing a mobile application integrating objects between distinct platforms, the method comprising:
identifying, with a unified repository and tool infrastructure, a location of middleware on different platforms to be integrated with a client platform;
accessing, with the unified repository and tool infrastructure, resources on the distinct platforms; and
federating the resources on the different platforms with the client platform to integrate with the client platform.
